(19) United States
(12) Patent Application Publication
(10) Pub. No.: US 2011/0315492 A1
(43) Pub. Date: Dec. 29, 2011

(54) DISK BRAKE

(76) Inventor: Takayasu SAKASHITA, Tokyo (JP)

(21) Appl. No.: 13/164,067

(22) Filed: Jun. 20, 2011

(30) Foreign Application Priority Data
Jun. 24, 2010 (JP) 144262/2010

(51) Int. Cl. F16D 65/18; F16D 65/21; F16D 55/02

(52) U.S. Cl. 188/72.1

(57) ABSTRACT

The present invention provides a disk brake capable of ensuring excellent actuation efficiency. A piston holding mechanism 34 mounted in a disk brake 1a includes a planetary gear speed reduction mechanism 36 configured to power up a rotation of a motor 38, and a screw mechanism 52 and a ball and ramp mechanism 28 configured to convert a rotation of the planetary gear speed reduction mechanism 36 into a linear motion to advance a piston 12 in parallel. The planetary gear speed reduction mechanism 36 transmits a rotational output provided by powering up an input from the motor 38 to the screw mechanism 52 or the ball and ramp mechanism 28, and transmits a reactive force of the rotational output to the screw mechanism 52 or the ball and ramp mechanism 28. The screw mechanism 52 maintains a braked state when a supply of a rotational force from the motor 38 is stopped. As a result, it is possible to ensure excellent actuation efficiency.

### TECHNICAL FIELD

The present invention relates to a disk brake for use in braking of a vehicle.

### BACKGROUND ART

Some disk brakes are configured to provide self-holding of a brake force for achieving the parking brake function with use of a worm speed reducer (refer to Japanese Patent Application Public Disclosure No. 2006-177532).

### DISCLOSURE OF THE INVENTION

### Problems to be Solved by the Invention

According to the disk brake disclosed in Japanese Patent Application Public Disclosure No. 2006-177532, the mechanical efficiency of the worm speed reducer should be set low as much as possible (in other words, the mechanical loss is increased as much as possible) for maintaining a thrust force to the piston. However, setting the mechanical efficiency of the worm speed reducer low results in a reduction in the actuation efficiency of the mechanism for achieving the parking brake function, which leads to such a problem that the motor should be bigger in size so as to be able to cover the reduced actuation efficiency to generate a desired thrust force to the piston.

An object of the present invention is to provide a disk brake capable of ensuring excellent actuation efficiency.

### Problems to be Solved by the Invention

To achieve the forgoing and other objects, the present invention provides a disk brake including a pair of pads disposed on opposite sides of a disk so as to sandwich the disk therebetween, one piston configured to press one of the pair of pads against the disk, a caliper main body including a cylinder movably containing the piston, an electric motor disposed at the caliper main body, and a piston holding mechanism disposed at the caliper main body and configured to maintain the piston at a brake applying position. The piston holding mechanism includes a speed reduction mechanism configured to power up a rotation of the electric motor, and a first rotation/linear motion conversion mechanism and a second rotation/linear motion conversion mechanism configured to convert a rotation of the speed reduction mechanism into a linear motion to selectively transmit the force to the one piston to thereby advance the one piston. The speed reduction mechanism transmits a rotational output provided by powering up an input of the electric motor to the first rotation/linear motion conversion mechanism, and a reactive force of the rotational output to the second rotation/linear motion conversion mechanism. At least one of the first and second rotation/linear motion conversion mechanisms maintains a stopped state of the one piston when an application of a transmission force is stopped.

According to the disk brake of the present invention, it is possible to ensure excellent actuation efficiency.

### BRIEF DESCRIPTION OF THE DRAWINGS

FIG. 1 is a cross-sectional view illustrating a disk brake according to a first embodiment when a parking brake is released;

FIG. 2 is a cross-sectional view taken along the line X-X shown in FIG. 1;

FIG. 3 is a cross-sectional view illustrating the disk brake according to the first embodiment when only a screw mechanism is actuated during an actuation of the parking brake;

FIG. 4 is a cross-sectional view illustrating the disk brake according to the first embodiment when a ball and ramp mechanism is also actuated, in addition to the screw mechanism during the actuation of the parking brake;

FIG. 5 is cross-sectional view illustrating a disk brake according to a second embodiment when a parking brake is released;

FIG. 6 is a cross-sectional view illustrating the disk brake according to the second embodiment when only a screw mechanism is actuated during an actuation of the parking brake; and

FIG. 7 is a cross-sectional view illustrating the disk brake according to the second embodiment when a plunger pump mechanism is also actuated, in addition to the screw mechanism during the actuation of the parking brake;

### BEST MODE FOR CARRYING OUT THE INVENTION

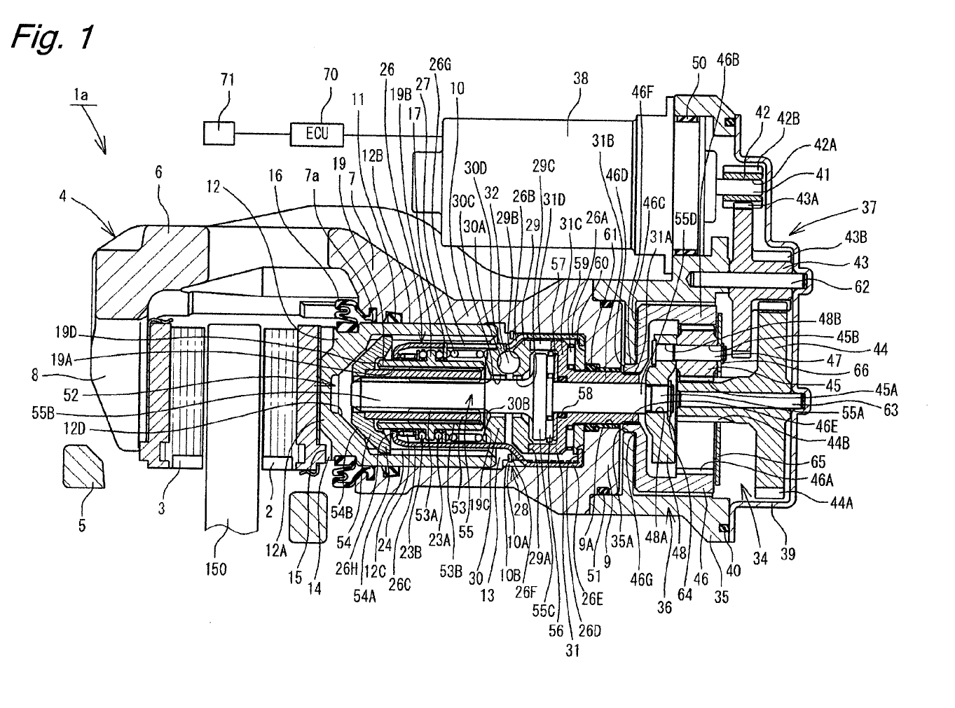

Hereinafter, embodiments of the present invention will be described in detail with reference to FIGS. 1 to 7. First, a disk brake 1a according to a first embodiment will be described, especially referring to FIGS. 1 to 4. FIG. 1 shows the disk brake 1a according to the first embodiment. The disk brake 1a includes a pair of brake pads and a caliper 4. The pair of brake pads is constituted by an inner brake pad 2 and an outer brake pad 3 disposed on the opposite sides of a disk rotor 150 attached to a rotational portion of a vehicle. The disk brake 1a is configured as a caliper floating type disk brake. The inner brake pad 2 and the outer brake pad 3, and the caliper 4 are supported at a carrier 5 fixed to a non-rotational portion of the vehicle such as a knuckle, so as to be movable in the axial direction of the disk rotor 150.

A caliper main body 6, which mainly constitutes the caliper 4, includes a cylinder portion 7 and a claw portion 8. The cylinder portion 7 is disposed on a proximal end side facing the inner brake pad 2 which is a brake pad on the vehicle inner side. The claw portion 8 is disposed on a distal end side facing the outer brake pad 3 which is a brake pad on the vehicle outer side. The cylinder portion 7 includes a bottomed cylinder 10 having a opening 7a at an end thereof facing the inner brake pad 2, and a bottom wall 9 closing the other end thereof. The cylinder 10 contains a piston 12 disposed so as to be axially movable while being in contact with the interior of the cylinder 10 through a piston seal 11.

The piston 12 has a cup-like shape, and is contained in the cylinder 10 in such a manner that a bottom 12A of the piston 12 is positioned to face the inner brake pad 2. A hydraulic chamber 13 is defined between the piston 12 and the bottom wall 9 of the cylinder 10. A hydraulic pressure is supplied from a not-shown hydraulic pressure source such as a master cylinder to the hydraulic chamber 13 through a not-shown port formed at the cylinder portion 7. The piston 12 is prevented from rotating by an engagement of a protrusion 15 formed on the back surface of the inner brake pad 2 with a recess 14 formed on the bottom surface of the piston 12. Further, a dust boot 16 is disposed between the bottom of the piston 12 and the cylinder 10 for preventing an entry of foreign objects into the cylinder 10.

A housing 35 is air-tightly attached to the bottom wall 9 side of the cylinder 10 of the caliper main body 6. A cover 39 is air-tightly attached to an opening of the housing 35 at one end of the housing 35. A seal 51 serves to maintain the airtightness between the housing 35 and the cylinder 10. A seal 40 serves to maintain the airtightness between the housing 35 and the cover 39. A motor 38, which is an example of an electric motor, is hermetically attached to the housing 35 of the caliper main body 6 through a seal 50. In the present embodiment, the motor 38 is disposed outside the housing 35, but the housing 35 may be formed so as to cover the motor 38, and the motor 38 may be contained in the housing 35. In this case, the seal 50 may be omitted.

Further, the caliper main body 6 includes a piston holding mechanism 34 for maintaining the piston 12 at a brake applying position. The piston holding mechanism 34 includes a multistage spur speed reduction mechanism 37 and a planetary gear speed reduction mechanism 36 as a speed reducing mechanism for powering up a rotation generated by the motor 38. The piston holding mechanism 34 further includes a screw mechanism 52 as one rotation/linear motion conversion mechanism, and a ball and ramp mechanism 28 as the other rotation/linear motion conversion mechanism, for moving the piston 12 by converting a rotational motion from the multistage spur speed reduction mechanism 37 and the planetary gear speed reduction mechanism 36 into a motion in a linear direction (hereinafter referred to as “linear motion” for convenience of description) to apply it to the piston 12 as a thrust force. The above-mentioned multistage spur speed reduction mechanism 37 and the planetary gear speed reduction mechanism 36 are contained in the housing 35, and the above-mentioned screw mechanism 52 and the ball and ramp mechanism 28 are contained in the cylinder 10 of the caliper main body 6.

### [Speed Reduction Mechanism]

The multistage spur speed reduction mechanism 37 includes a pinion gear 42, a first speed reduction gear 43, and a second speed reduction gear 44. The pinion gear 42 is formed into a cylindrical shape, and includes a hole 42A through which a shaft 41 of the motor 38 is fixedly press-fitted, and a gear 42B formed on the outer circumference. The first speed reduction gear 43 includes a large gear 43A, and a small gear 43B integrally formed with the large gear 43A. The large gear 43A has a larger diameter, and is meshed with the gear 42B of the pinion gear 42. The small gear 43B has a smaller diameter, and is formed to axially extend from the large gear 43A. The first speed reduction gear 43 is rotatably supported by a shaft 62 which has one end supported by the housing 35 and the other end supported by the cover 39. The second speed reduction gear 44 includes a large gear 44A, and a sun gear 44B integrally formed with the large gear 44A. The large gear 44A has a larger diameter, and is meshed with the small gear 43B of the first speed reduction gear 43. The sun gear 44B has a smaller diameter, and is formed to axially extend from the large gear 44A. The sun gear 44B constitutes a part of the planetary gear speed reduction mechanism 36 which will be described later. This second speed reduction gear 44 is rotatably supported by a shaft 63 supported by the cover 39.

### [Speed Reduction Mechanism (Planetary Gear Speed Reduction Mechanism]

The planetary gear speed reduction mechanism 36 includes the above-mentioned sun gear 44B, a plurality of planetary gears 45 (three planetary gears in the present embodiment), an internal gear 46, and a carrier 48. The planetary gears 45 each include a gear 45A and a hole 45B. The gear 45A is meshed with the sun gear 44B which is formed at the second speed reduction gear 44 and serves as an input portion of a rotation of the motor 38. The hole 45B receives an insertion of a pin 47 erected at the carrier 48. The three planetary gears 45 are equiangularly disposed on the circumference of the carrier 48.

The carrier 48 is formed into a disk-like shape, and includes a hole 48A formed at the center thereof. The hole 48A has a spline groove. The hole 48A is spline-engaged with the rear end side (the right side as viewed in FIG. 1) of a spindle 55 of the screw mechanism 52, thereby functioning to transmit a rotational torque between the carrier 48 and the spindle 55. Pin holes 48B are formed at the periphery side of the carrier 48, through which a plurality of pins 47 are fixedly press-fitted to rotatably support the above-mentioned planetary gears 45, respectively. The carrier 48 is prevented from axially moving relative to the spindle 55 by a clip 64 fixedly attached to the rear end of the spindle 55 inserted through the hole 48A. Further, the pins 47 each have one end side fixedly press-fitted through the pin hole 28B of the carrier 48. The clip 66 is fixedly attached to the other end side of the pin 47 to function to prevent the planetary gear 45 together with a washer 65, which each of the pins 47 is inserted therethrough, from axially moving relative to the pin 47. The carrier 48 is configured as a first or second output portion in the present embodiment.

The internal gear 46 includes inner teeth 46A, a large-diameter cylindrical portion 46B, an annular portion 46C, a small-diameter cylindrical portion 46D, and a hole 46E. The inner teeth 46A are meshed with each of the gears 45A of the planetary gears 45. The large-diameter cylindrical portion 46B axially extends from the inner teeth 46A. The annular portion 46C is formed at the opposite end of the large-diameter cylindrical portion 46B from the inner teeth 46A. The small-diameter cylindrical portion 46D axially extends from the center of the annular portion 46C. The hole 46E has a spline groove formed on the inner circumferential surface of the small-diameter cylindrical portion 46D. The internal gear 46 is rotatably supported at an outer circumferential surface 46F of the small-diameter cylindrical portion 46D by the opening 35A of the housing 35. The internal gear 46 further includes an annular abutment portion 46G formed at the annular portion 46C near the small-diameter cylindrical portion 46D, and therefore can abut against the housing 35 in the vicinity of the opening 35A of the housing 35. The internal gear 46 is prevented from axially moving relative to the housing 35 due to the washer 65 disposed at the carrier 48 and the housing 35 in abutment with the above-mentioned abutment portion 46G. Further, the hole 46E of the internal gear 46 is spline-engaged with an input shaft 31 of the above-mentioned ball and ramp mechanism 28, thereby enabling transmission of a rotational torque therebetween. The internal gear 46 is configured as the first or second output portion in the present embodiment, together with the above-mentioned carrier 48.

### [Rotation/Linear Motion Conversion Mechanism (Screw Mechanism)]

The screw mechanism 52 as the one rotation/linear motion conversion mechanism includes a nut 53, a flange 54, and the spindle 55. The spindle 55 includes a fitted portion 55 formed at the rear end side (the right end side as viewed in FIG. 1) thereof. The fitted portion 55 has a spline groove to be spline-engaged with the hole 48A of the carrier 48 as mentioned above, and therefor can function to transmit a rotational torque between the carrier 48 and the spindle 55. The tip end side (the left end side as viewed in FIG. 1) of the spindle 55 includes a male screw portion 55B with a screw groove formed thereon. The nut 53 as a linear motion member is screwed with the male screw portion 55B. A radially protruding collar 55C is formed at a substantially axially central portion of the spindle 55 and the proximal end of the male screw portion 55B. The collar 5C is axially supported by the input shaft 31 of the ball and ramp mechanism 28, which will be described later, through a thrust bearing 56 and a thrust washer 57. Due to these supports, the spindle 55 is rotatably supported by the caliper 4 through the input shaft 31. An insertion portion 55D is formed between the above-mentioned fitted portion 55A and the collar 55C, extending through the hole 9A formed through the bottom wall 9 of the above-mentioned caliper 4.

The nut 53 is formed into a cylindrical shape as a whole, and includes a female screw portion 53A and a male screw portion 53B. The female screw portion 53A is formed on the inner circumferential surface on one end side of the nut 53 to be screwed with the male screw portion 55B of the above-mentioned spindle 55. The male screw portion 53B is formed on the outer circumferential side of the female screw portion 53A to be screwed with a push rod 19 of the ball and ramp mechanism 28 which will be described later. The lead of the screw groove between the male screw portion 55B of the spindle 55 and the female screw portion 53A of the nut 53 is set to such a lead that, during an application of a thrust force, i.e., an axial force causing the piston 12 to be positioned on the brake applying position, the spindle 55 and the nut 53 are not rotatable relative to each other, in other words, the spindle 55 is not rotated by the axial force applied to the nut 53, therefore preventing a reverse operation. Because the screw mechanism 52 includes these male screw portion 55B and the female screw portion 53A, the mechanical efficiency of the screw mechanism 52 is low (for example, the mechanical efficiency η is approximately 10 to 15). However, due to these male screw portion 55B and the female screw portion 53A, the screw mechanism 52 can maintain the piston 12 at the brake applying position upon an actuation of the piston holding mechanism 34.

The flange 54 is formed into a substantially conical shape, and is configured in such a manner that the other end of the above-mentioned nut 53 is fixedly attached to the inner circumferential surface on the tip end side of the flange 54. A plurality of protrusions 54A is formed at the outer circumferential end of the flange 54. The plurality of protrusions 54A is configured to be engaged with a plurality of grooves 12C circumferentially formed on the inner circumferential surface of a cylinder portion 12B of the piston 12 so as to axially extend thereon. Due to the engagement between the protrusions 54A and the grooves 12C of the piston 12, the nut 53 and the flange 54 are allowed to axially move relative to the piston 12 but are prevented from rotationally moving relative to the piston 12. An inclined surface 54B is formed on the outer circumferential surface of the flange 54. This inclined surface 54B is abuttable against an inclined surface 12D formed on the inner surface of a bottom 12A of the piston 12. With the aid of the abutment of the inclined surface 54B of the flange 54 against the inclined surface 12D of the piston 12, a rotational force of the motor 38 can be transmitted through the spindle 55, the nut 53, and the flange 54, which constitute the screw mechanism 52, to thrust the piston 12 to the brake applying position, and at the same time, the piston 12 can be maintained at the brake applying position. A not-shown plurality of axial grooves is formed on the inclined surface 54B of the flange 54 or the inclined surface 12D of the piston 12. These axial grooves serve to maintain communication between a space defined by the bottom 12A of the piston 12 and the flange 54 and the interior of the cylindrical portion 12B of the piston 12, thereby enabling a flow of brake fluid and ensuring the air release performance of the above-mentioned space.

In the present embodiment, the screw mechanism 52 constitutes the one rotation/linear motion conversion mechanism, especially, the rotation/linear motion conversion mechanism for maintaining a braked state when an application of a transmission force is stopped. Further, in the present embodiment, the nut 53 and the flange 54 constitute the linear motion member of the screw mechanism.

### [Rotation/Linear Motion Conversion Mechanism (Ball and Ramp Mechanism]

The ball and ramp mechanism 28, which corresponds to the other rotation/linear motion conversion mechanism, includes the input shaft 31, a rotational plate 29, a linear motion plate 30, a plurality of balls 32, a spring 27, and the push rod 19. They are put together by a retainer 26 as an assembly.

The input shaft 31 includes a cylindrical portion 31B, an annular portion 31C having an annular shape, and a plurality of claw portions 31D. The cylindrical portion 31B has a spline groove 31A on one end thereof. This spline groove 31A is spline-engaged with the hole 46E of the above-mentioned internal gear 46. The annular portion 31C is formed on the other end side of the cylindrical portion 31B, and supports the collar 55C of the above-mentioned spindle 55 through the thrust bearing 56 and the thrust washer 57. The plurality of claw portions 31D are formed to axially extend on the peripheral side of the annular portion 31C to be engaged with the above-mentioned rotational plate 29. The above-mentioned cylindrical portion 31B is inserted through the hole 9A formed through the bottom wall 9 of the above-mentioned caliper 4, and receives an insertion of the insertion portion 55D of the spindle 55 within the inner circumferential side thereof. A seal 58 is disposed between the insertion portion 55D of the spindle 55 and the inner circumferential surface of the cylindrical portion 31B of the input shaft 31, and a seal 61 is disposed between the hole 9A of the bottom wall 9 of the cylinder 10 and the outer circumferential surface of the cylindrical portion 31B of the input shaft 31. These seals 58 and 61 ensure the liquid-tightness of the hydraulic pressure chamber 13. The above-mentioned annular portion 31C is axially supported by the bottom wall 9 of the cylinder 10 through the thrust bearing 59 and the thrust plate 60, whereby the input shaft 31 is rotatably supported by the caliper 4.

The rotational plate 29 is formed into a substantially annular shape, and includes a plurality of grooves 29A on one surface side, a plurality of ball grooves 29B on the other surface side which is a surface facing the linear motion plate 30, and a hole 29C at the center thereof. The plurality of claw portions 31D of the above-mentioned input shaft 31 is fitted in the plurality of grooves 29A. The ball grooves 29B each extend to define an arcuate shape with a predetermined inclined angle along the circumferential direction, and have an arcuate shape in cross section in the radial direction. The hole 29 receives an insertion of the proximal end side of the male screw portion 55B of the above-mentioned spindle 55. The above-mentioned plurality of grooves 29A and the claw portions 31D of the input shaft 31 are fitted to each other in such a manner that the tips of the claw portions 31D can abut against the bottoms of the grooves 29A, and a rotational force of the input shaft 31 is transmitted to the rotational plate 29. Regarding this structure, the grooves 29A and the claw portions 31D may be fitted with a slight backlash generated in the rotational direction. Alternatively, the claw portions 31D may be press-fitted in the grooves 29A. In the present embodiment, this rotational plate 29 is configured as a rotational member of the ball and ramp mechanism.

The linear motion plate 30 is formed into a substantially annular shape, and includes a plurality of ball grooves 30A, a plurality of protrusions 30D, a hole 30C, and an inclined surface 30B. The ball grooves 30A are formed on one surface side which is a surface facing the rotational plate 29. The ball grooves 30A extend to define an arcuate shape with a predetermined inclined angle along the circumferential direction, and have an arcuate shape in cross section in the radial direction. The protrusions 30D are formed on the peripheral side, and are fitted into cutouts 26G formed at the above-mentioned retainer 26 along the axial direction. The hole 30C is formed at the center of the linear motion plate 30, and receives an insertion of the proximal end side of the male screw portion 55B of the above-mentioned spindle 55. The inclined surface 30B is formed on the other surface side, and is frictionally engaged with the push rod 19. In the present embodiment, this linear motion plate 30 is configured as a linear motion member of the ball and ramp mechanism.

The balls 32 each are constituted by a steel ball as a rollable member, and are respectively disposed between the plurality of ball grooves 29B of the above-mentioned rotational plate 29 and the plurality of ball grooves 30A of the linear motion plate 30. Then, a rotation of the rotational plate 29 causes rolling motions of the balls 32 between the ball grooves 29B and 30A, thereby causing an axial movement of the linear motion plate 30 since the linear motion plate 30 is prevented from rotating by the protrusions 30D fitted in the retainer 26. The ball grooves 29B and 30A may be configured in such a manner that the inclination thereof has a change along it, such as an addition of a recess to a position along the inclination extending in the circumferential direction.

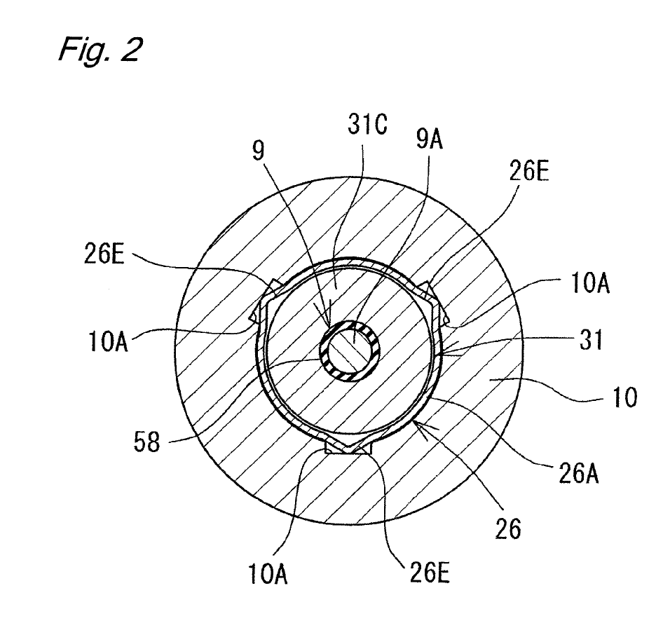

The retainer 26 is formed into a substantially cylindrical shape as a whole, and includes a large-diameter portion 26A, a reduced-diameter portion 26B, and a small-diameter portion 26C. The large-diameter portion 26A is positioned nearest to the bottom wall 9 of the cylinder 10. The reduced-diameter portion 26B has a decreasing diameter from the large-diameter portion 26A toward the opening 7a of the cylinder 10. The small-diameter portion 26C extends from the reduced diameter portion 26B toward the opening 7a of the cylinder 10. A plurality of engagement portions 26D, by which the thrust plate 60 is engaged, are formed by partially interfolding one end (the right side as viewed in FIG. 1) of the large-diameter portion 26A toward the thrust plate 60. Further, as shown in FIG. 2, a plurality of protrusions 26E, which partially protrudes to the outer circumferential side, is formed on the circumferential surface of the large-diameter portion 26A. These protrusions 26E are configured to be fitted into axial grooves 10A formed on the cylinder 10 near the bottom wall 9 along the axial direction. The protrusions 26E of the retainer 26 are fitted into the axial grooves 10A of the cylinder 10 in this way, whereby the retainer 26, and therefore the whole ball and ramp mechanism 28 are prevented from rotating relative to the caliper 4. The reduced diameter portion 26B includes a plurality of protrusions 26F formed to partially protrude to the outer circumferential side along the circumferential direction. These protrusions 26F abut against a C-shaped ring 10B fixedly attached in the cylinder 10, whereby the retainer 26 and therefore the whole ball and ramp mechanism 28 are prevented from axially moving, and are supported by the caliper 4.

A plurality of cutouts 26G, into which the protrusions 30D of the above-mentioned linear motion plate 30 are fitted, are formed along the axial direction from the reduced diameter portion 26B to an intermediate position of the small-diameter portion 26C of the retainer 26. A washer 17 is engaged in each of the cutouts 26G, and a spring 27 as a biasing means is disposed between the washer 17 and the linear motion plate 30. This spring 27 functions to bias the linear motion plate 30 toward the rotational plate 29, whereby the balls 32 can be maintained between the ball grooves 29A of the rotational plate 29 and the ball grooves 30A of the linear motion plate 30. The tip end side of the small-diameter portion 26C is infolded toward the inner diameter, and thereby constitutes a spring bearing 26H serving as a spring bearing for a spring 24 which will be described later.

### [Rotation/Linear Motion Conversion Mechanism (Adjustment Mechanism of Ball and Ramp Mechanism)]

The push rod 19 as an adjustment mechanism is disposed between the linear motion plate 30 of the ball and ramp mechanism 28 and the flange 54 of the screw mechanism 52. The push rod 19 is formed into a substantially cylindrical shape as a whole, and includes a female screw portion 19A, an annular flange portion 19B, a frictional surface 19C, and an abutment surface 19D. The female screw portion 19A is formed on the inner circumferential surface of the push rod 19, and is screwed with the male screw portion 53B on the outer circumferential surface of the nut 53. The annular flange portion 19B is formed at an axially central position on the outer circumferential surface of the push rod 19 so as to radially outwardly protrude. The frictional surface 19C is formed on one axial end side (the right end as viewed in FIG. 1) of the push rod 19, and is able to be frictionally engaged with the inclined surface 30B of the above-mentioned linear motion plate 30. The abutment surface 19D is formed on the other axial end side (the left end as viewed in FIG. 1) of the push rod 19, and is able to abut against the inner circumferential surface of the flange 54 of the above-mentioned screw mechanism 52. The above-mentioned female screw portion 19A is constituted by a multiple thread screw. Further, the above-mentioned flange portion 19B is supported so as to be rotatable relative to the retainer 26 through bearings 23A and 23B, and is biased toward the linear motion plate 30 (the right side as viewed in FIG. 1) by the spring 24. This structure enables the push rod 19 to be rotated due to the engagement with the male screw 53B of the nut 53 during a linear motion of the nut 53 while keeping the axial position of the push rod 19 unchanged until the linear motion plate 30 abuts against the push rod 19.

The mechanical efficiency of the ball and ramp mechanism 28 configured as mentioned above is set to be higher than the mechanical efficiency of the screw mechanism 52 (for example, the mechanical efficiency of the mechanism 28 η is approximately 80 to 90), since the ball and ramp mechanism 28 does not have to maintain the piston 12 at the brake applying position when the piston holding mechanism 34 is actuated. Therefore, according to the present embodiment, the piston holding mechanism 34, which is constructed by combining the screw mechanism 52 having low mechanical efficiency and the ball and ramp mechanism 28 having high mechanical efficiency, can achieve relatively high mechanical efficiency as a whole (for example, the mechanical efficiency η is approximately 20 to 30), whereby it is possible to ensure excellent actuation efficiency of the piston holding mechanism 34 of the disk brake. Further, the above-described ball and ramp mechanism 28 has excellent reverse operability due to its high mechanical efficiency, thereby enabling the linear motion plate 30 to be returned to an initial position (a position close to the rotational plate 29) by the biasing force of the spring 27 when driving of the motor 38 is stopped. In the present embodiment, the ball and ramp mechanism 28 constitutes the other rotation/linear motion conversion mechanism.

As mentioned above, in the present embodiment, the screw mechanism 52 and the ball and ramp mechanism 28 are constructed as an assembly by the retainer 26, and the parts in the cylinder 10 can be assembled only by inserting this assembly into the cylinder 10 and fixedly attaching the C-shaped ring 10B, thereby enabling a reduction in the processes for the assembling of the parts in the cylinder 10, resulting in improvement in the manufacturing efficiency of the disk brake 1a.

Next, an operation of the disk brake 1a according to the first embodiment will be described. First, a description will be given of a braking operation of the disk brake 1a as a normal hydraulic brake actuated by a driver's depression of the brake pedal. When a driver presses down the brake pedal, a hydraulic pressure according to the pressing force applied to the brake pedal is supplied from a master cylinder (not shown) to the hydraulic chamber 13 in the caliper 4 through a hydraulic circuit. This supply causes the piston 12 to move forward (moves in the left direction as viewed in FIG. 1) while deforming the piston seal 11, pressing the inner brake pad 2 against the disk rotor 150. The reactive force at this time causes the caliper 4 to move relative to the carrier 5 in the right direction as viewed in FIG. 1, thereby causing the outer brake pad 3 attached to the claw portion 8 to be pressed against the disk rotor 150. As a result, the disk rotor 150 is sandwiched by the pair of inner and outer brake pads 2 and 3, generating a brake force for braking the vehicle.

When the driver releases the brake pedal, the supply of the hydraulic pressure from the master cylinder is stopped so that the hydraulic pressure in the hydraulic pressure chamber 13 is reduced. This reduction causes the piston 12 to move back to its original position due to the elasticity of the piston seal 11 to release the brake force. When the movement amount of the piston 12 is increased according to wear states of the inner and outer brake pads 2 and 3, the original position of the piston 12 is moved due to a slip generated between the piston 12 and the piston seal 11, thereby adjusting the pad clearance to maintain a constant distance.

Next, an operation as the parking brake will be described as an example of an operation for maintaining a braked state of the vehicle. FIG. 1 illustrates the disk brake 1a when the parking brake is released. When a driver operates a parking switch 71 to actuate the parking brake from this state, the motor 38 is driven by the ECU 70, and the sun gear 44B of the planetary gear speed reduction mechanism 36 is rotated via the multistage spur speed reduction mechanism 37. At this time, a rotational torque is applied to the carrier 48 and the internal gear 46 of the planetary gear speed reduction mechanism 36 so that they are supposed to rotate in reverse directions of each other at a predetermined ratio (speed reduction ratio).

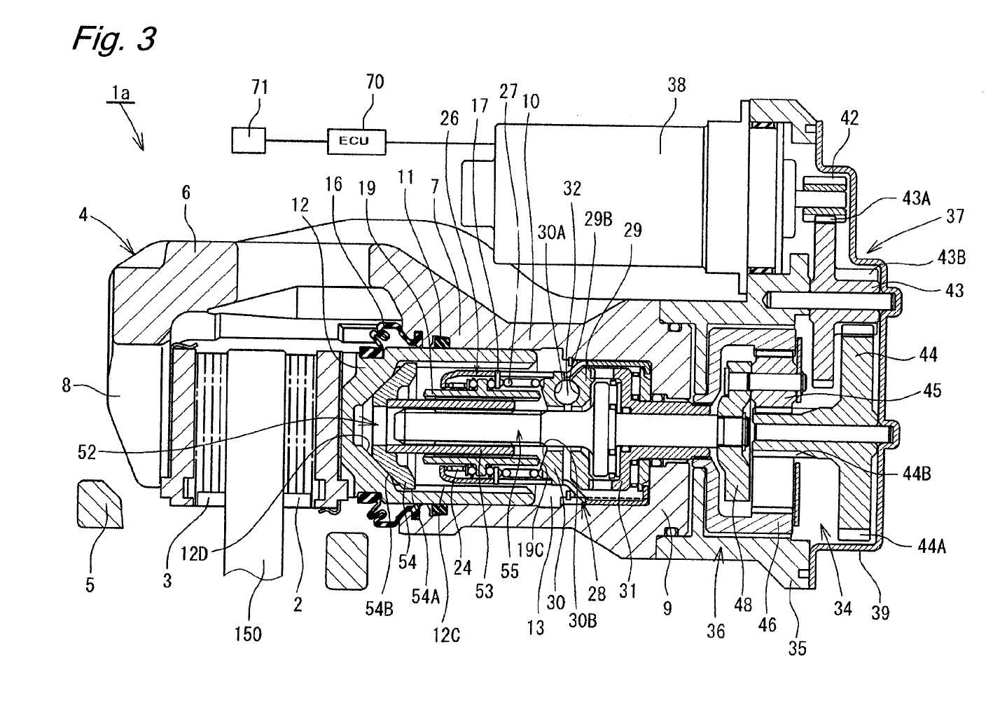

At this time, in the ball and ramp mechanism 28, a torque of a certain magnitude or more is required to move the linear motion plate 30 forward (in the left direction as viewed in FIG. 1) due to the biasing force of the spring 27. However, the torque for rotating the spindle 55 is sufficiently reduced when no braking force (pressing force) is generated from the pair of inner and outer brake pads 2 and 3 to the disk rotor 150. Therefore, as shown in FIG. 3, the rotational force from the sun gear 44B of the planetary gear speed reduction mechanism 36 is transmitted to the carrier 48 via the respective planetary gears 45 to cause the screw mechanism 52 to start an operation. At this time, the ball and ramp mechanism 28 is not yet actuated, and the internal gear 46 is not yet rotated. Therefore, the rotational force of the motor 38 is mostly transmitted to the screw mechanism 52 except for an amount corresponding to a mechanical loss. As a result, the screw mechanism 52 can operate with sufficiently high mechanical efficiency. Then, in the screw mechanism 52, the spindle 55 is rotated by the rotational force from the carrier 48, thereby causing the nut 53 and the flange 54 to move forward (move in the left direction as viewed in FIG. 1). Then, the abutment and pressing of the inclined surface 54B of the flange 54 against the inclined surface 12D of the piston 12 cause the piston 12 to move forward. At this time, since the nut 53 is screwed with the push rod 19, the push rod 19 receives a force for moving the push rod 19 forward according to the forward movement of the nut 53. However, the axial position of the push rod 19 is unchanged from the position shown in FIG. 1 due to the biasing force of the spring 24, and instead the push rod 19 is rotated, remaining at that position to adjust the positional relationship between the nut 53 and the push rod 19, i.e., to increase the total axial length of the nut 53, the flange 54, and the push rod 19.

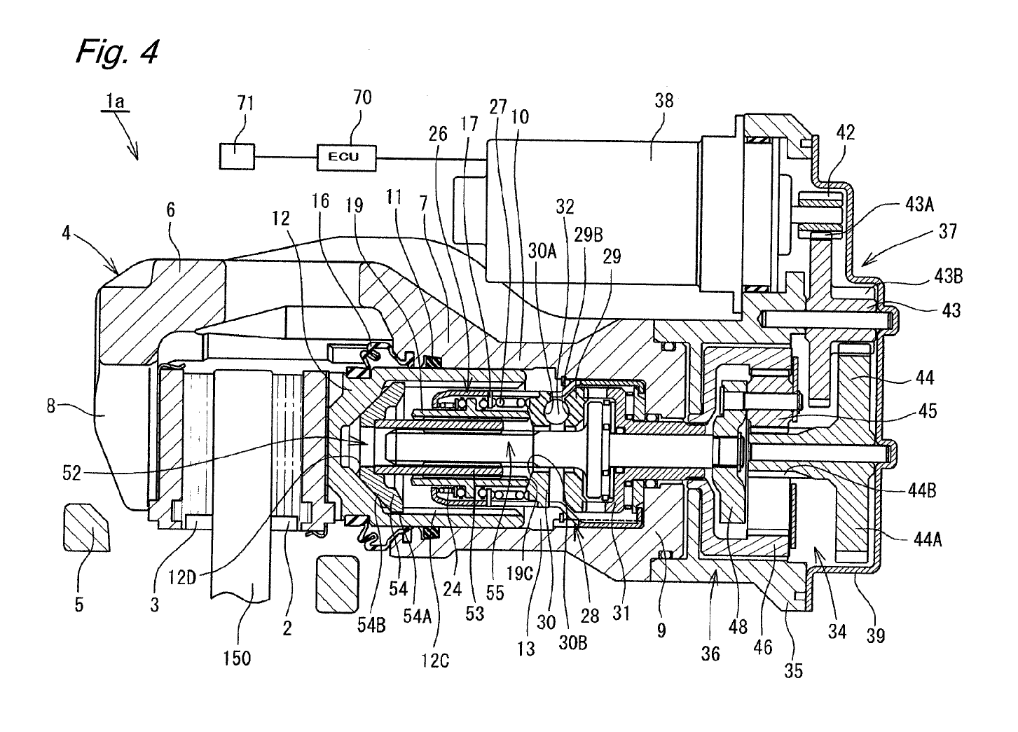

Next, when the motor 38 is further rotated so as to start generation of a brake force applied to the disk rotor 150 by the operation of the screw mechanism 52, at this time, the rotational torque for rotating the spindle 55 is increased to become larger than the rotational torque for actuating the ball and ramp mechanism 28. As a result, as shown in FIG. 4, the rotational force from the sun gear 44B of the planetary gear speed reduction mechanism 36 is transmitted to the internal gear 46 via the respective planetary gears 45, whereby the ball and ramp mechanism 28 starts to operate. Then, in the ball and ramp mechanism 28, the input shaft 31 and the rotational plate 29 are rotated by the rotational force from the internal gear 46, causing the linear motion plate 30 to move forward. Then, the inclined surface 30B of the linear motion plate 30 starts to abut against the frictional surface 19C of the push rod 19 to press the push rod 19. As mentioned above, since the inclined surface 30B of the linear motion plate 30 is frictionally engaged with the frictional surface 19C of the push rod 19, the push rod 19 is prevented from being rotated. Therefore, the pressing force from the push rod 19 (the ball and ramp mechanism 28) is transmitted to the nut 53 and the flange 54 through the multi thread screw, thereby increasing the brake force to be applied to the disk rotor 150. In the present embodiment, first, the nut 53 and the flange 54 move forward by the screw mechanism 52, which causes the piston 12 to move forward to obtain a brake force applied to the disk rotor 150. Therefore, wear of the pair of inner and outer brake pads 2 and 3, which may occur over time, can be compensated by the operation of the screw mechanism 52.

Next, upon an increase in the brake force (pressing force) from the ball and ramp mechanism 28 to the disk rotor 150 and an increase in the torque for rotating the input shaft 31, at this time, the rotational force from the sun gear 44B of the planetary gear speed reduction mechanism 36 is transmitted to the carrier 48 through the respective planetary gears 45. The rotational force from the carrier 48 actuates the screw mechanism 52, i.e., rotates the spindle 55 to move the nut 53 and the flange 54 forward, thereby further increasing the brake force applied to the disk rotor 150. In this way, it is possible to increase the brake force applied to the disk rotor 150 by moving forward the piston 12 with use of the screw mechanism 52 and the ball and ramp mechanism 28 while keeping a predetermined ratio. Then, the ECU 70 continues to drive the motor 38 until the brake force from the pair of inner and outer brake pads 2 and 3 to the disk rotor 150 reaches a predetermined value.

In this way, in the disk brake 1a according to the first embodiment, when the piston 12 is maintained at the brake applying position to, for example, exert the parking brake, for an application of the brake force from the pair of inner and outer brake pads 2 and 3 to the disk rotor 150, the piston holding mechanism 34 achieves relatively high mechanical efficiency as a whole (for example, the mechanical efficiency η is approximately 20 to 30), because it is constituted by a combination of the screw mechanism 52 having low mechanical efficiency and the ball and ramp mechanism 28 having high mechanical efficiency. Therefore, it is possible to ensure excellent actuation efficiency of the piston holding mechanism 34 of the disk brake. Further, not only the pressing force from the screw mechanism 52 but also the pressing force from the ball and ramp mechanism 28 are applied to the piston 12, whereby it is possible to obtain a desired brake force even with the motor 38 having a reduced size. As a result, the reduction in the size of the motor 38 (a reduction in the required torque) leads to a reduction in the torque applied to the multistage spur speed reduction mechanism 37 and the planetary gear speed reduction mechanism 36, which is advantageous in terms of tranquility and longevity.

Next, when the brake force to the disk rotor 150 reaches a predetermined value, the ECU 70 stops to drive the motor 38 by ceasing a power supply to the motor 38. Then, only the ball and ramp mechanism 28 is caused to operate in the reverse direction from the direction when the mechanism 28 receives an input, and then be returned to the initial position (the position shown in FIG. 3) due to the reactive force from the pressing force to the disk rotor 150 and the biasing force of the spring 27. However, the screw mechanism 52 is not caused to operate by the reactive force from the pressing force, thereby maintaining the brake force as applied. In this way, an actuation of the parking brake is completed.

When the driving of the motor 38 is stopped to remove a pressing force from the ball and ramp mechanism 28 to the disk rotor 150, the reactive force to the screw mechanism 52 is increased accordingly, as a result of which the screw mechanism 52 is elastically deformed. This elastic deformation leads to a reduction in the pressing force applied to the disk rotor 150. Therefore, the target current value and the drive time of the motor 38 should be set so that the driving of the motor 38 is not stopped until generation of a pressing force (brake force) including even an additional amount corresponding to the elastic deformation of the screw mechanism 52.

Further, if a large torque is required to cause the multistage spur speed reduction mechanism 37 and the planetary gear speed reduction mechanism 36 to operate in the reverse direction, and therefore only the reactive force from the pressing force and the biasing force of the spring 27 are not enough to cause the ball and ramp mechanism 28 to operate in the reverse direction, power may be supplied to the motor 38 so that the motor 38 operates in the direction for returning the piston 12 after the driving of the motor 38 is stopped. In this case, the screw mechanism 52 is actuated when the ball and ramp mechanism 28 is returned to the initial position, and a current value of the motor 38 is suddenly increased since a relatively large torque is required at this time. Therefore, whether the ball and ramp mechanism 28 is returned to the initial position can be recognized by detecting a sudden change in the current value, and the power supply to the motor 38 can be stopped based on the detection.

Next, the parking brake can be released as follows. The ECU 70 actuates the motor 38 in the direction for returning the piston 12 when a driver operates the parking switch 71 so as to release the parking brake, whereby the multistage spur speed reduction mechanism 37 and the planetary gear speed reduction mechanism 36 are actuated in the direction for returning the piston 12. At this time, the ball and ramp mechanism 28 is returned to the initial position when the actuation of the parking brake has been already completed. Therefore, the internal gear 46 of the planetary gear speed reduction mechanism 36 which is spline-engaged with the input shaft 31 is not rotated. Therefore, in the planetary gear speed reduction mechanism 36, only the carrier 48 is rotated. In this case, since all of the rotational amount of the motor 38 can be used as the rotational amount of the carrier 48, and the rotational amount for returning the ball and ramp mechanism 28 to the initial position is unnecessary, the piston 12 can be quickly returned, compared to the speed when the piston 12 is moved forward. Further, since the screw mechanism 52 can be actuated in the force reduction direction by a smaller torque than that when the screw mechanism 52 is actuated in the power increase direction (the screw can be loosened by a smaller force than that for tightening the screw), the brake force applied from the pair of inner and outer brake pads 2 and 3 to the disk rotor 150 can be released by rotating the spindle 55 in the direction for returning the piston 12 through the carrier 48 of the planetary gear speed reduction mechanism 36 without the assist of the ball and ramp mechanism 28. In this way, the parking brake can be released by actuating only the screw mechanism 52, whereby it is possible to reduce the total rotational amount of the motor 38 and to improve the responsiveness and actuation efficiency of the piston holding mechanism 34 of the disk brake.

In the present embodiment, the speed reduction mechanism for actuating the screw mechanism 52 and the ball and ramp mechanism 28 is embodied by the planetary gear speed reduction mechanism 36, but may be embodied by another known speed reducer including concentric three axes, such as a cycloidal speed reducer and a wave speed reducer.

Further, as the present embodiment, the actuation of the piston holding mechanism 43 has been described, based on an example of the parking brake which is an example of an operation for maintaining a braked state of a vehicle. However, the piston holding mechanism 34 may be actuated for not only the parking brake but also, for example, a hill start assist or a hill down assist for aiding in a start of a vehicle on a slope, or an auto stop when accelerator-off occurs.

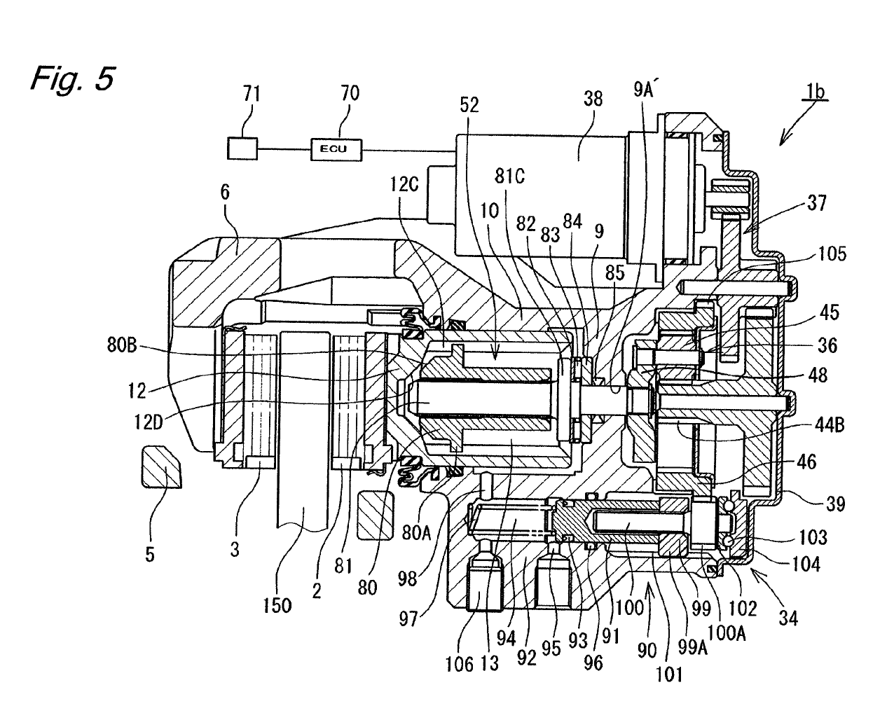

Next, a disk brake 1b according to a second embodiment will be described in detail with reference to FIGS. 5 to 7. In the following description of the disk brake 1b according to the second embodiment, only differences from the disk brake 1a according to the first embodiment will be described. In this description, like reference numerals are used to refer to like members as in the disk brake 1a according to the first embodiment. As shown in FIG. 5, the disk brake 1b according to the second embodiment includes the caliper main body 6 having the piston holding mechanism 34 constituted by the screw mechanism 52 as one rotation/linear motion conversion mechanism disposed in the cylinder 10, and a plunger pump mechanism 90 as the other rotation/linear motion conversion mechanism disposed at a position outside the cylinder 10.

The screw mechanism 52 is constituted by a nut 80 and a spindle 81 screwed with each other. A plurality of protrusions 80A is formed on the outer circumference of the nut 80 along the circumferential direction. The protrusions 80A of the nut 80 are engaged with a plurality of grooves 12A which is formed on the inner circumferential surface of the piston 12 along the circumferential direction so as to axially extend. As a result, the nut 80 is allowed to move in the axial direction but is prevented from moving in the rotational direction relative to the piston 12. Further, an inclined surface 80B formed at the tip (the left end as viewed in FIG. 5) of the nut 80 can transmit or maintain a thrust force by abutting against an inclined surface 12D formed on the bottom of the piston 12.

A collar 81C of the spindle 81 is supported by the bottom wall 9 of the cylinder 10 through a thrust washer 82, a thrust bearing 83, and a thrust washer 84. Further, the rear end of the spindle 81 is inserted through a hole 9A′, which is formed through the bottom wall 9 of the cylinder 10, to be spline-engaged with the carrier 48 of the planetary gear speed reduction mechanism 36. A seal 85 is disposed between the spindle 81 and the bottom wall 9 of the cylinder 10, and the seal 85 maintains the liquid-tightness of the hydraulic chamber 13.

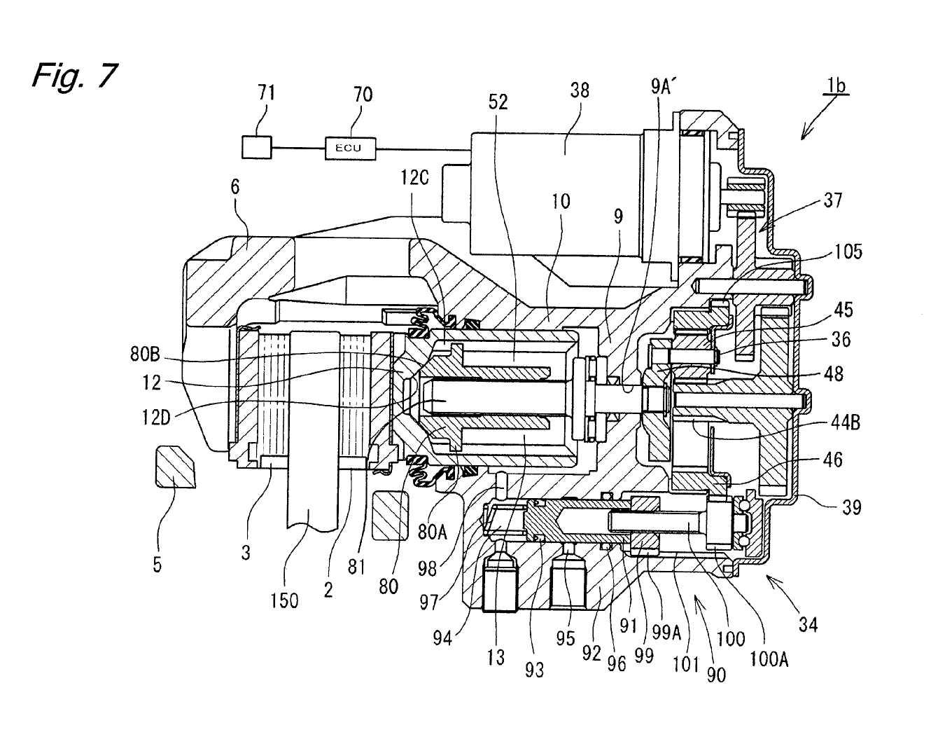

The plunger pump mechanism 90 generally includes a piston 91, a small cylinder 92 formed at the caliper main body 6, a nut 99, and a pump spindle 100. The piston 91 is constantly biased toward the cover 39 (the right side as viewed in FIG. 5) by a return spring 97 disposed in a hydraulic chamber 94 defined in the small cylinder 92. A cup seal 93 is attached around the outer circumference of the tip (the left end as viewed in FIG. 5) of the piston 91. Therefore, as shown in FIG. 7, when the piston 91 moves toward the hydraulic chamber 94 (the left side as viewed in FIG. 7) and the cup seal 93 moves beyond the port 95 connected to a not-shown hydraulic source such as a master cylinder, the communication is broken between the interior of the hydraulic chamber 94 defined by the piston 91 and the small cylinder 92, and the port 95. The hydraulic chamber 94 is also in communication with the hydraulic chamber 13 through a port 98. The reference numeral 106 in FIG. 5 denotes a plug of a brake fluid pipe. As shown in FIG. 7, when the cup seal 93 is positioned on the left side of the port 95, the brake fluid from the port 95 connected to the hydraulic source is prevented from leaking to the planetary gear speed reduction mechanism 36 due to the provision of the seal 96.

The nut 99 is disposed at the rear end side (the right end as viewed in FIG. 5) of the piston 91 with the pump spindle 100 screwed with the nut 99. A protrusion 99A is formed on the outer circumference of the nut 99 to be engaged with a groove 101 formed in the caliper main body 6. Due to this engagement, the nut 99 is allowed to move in the axial direction but is prevented from moving in the rotational direction. The pump spindle 100 is rotatably supported by a thrust washer 102, a thrust ball bearing 103, and a thrust bearing cover 104. The thrust bearing cover 104 is fixed to the caliper main body 6 by a bolt although this is not shown in the drawings. Further, a small gear 100A is integrally formed at the pump spindle 100, and the small gear 100A is meshed with a large gear 105 formed on the outer circumference of the internal gear 46 of the planetary gear speed reduction mechanism 36. This arrangement enables the spindle 100 to rotate according to a rotation of the internal gear 46 and then the nut 99 to move forward toward the hydraulic chamber 94 (the left side as viewed in FIG. 5) to press the piston 91. At this time, since the screw portion of the nut 99 and spindle 100 does not have to maintain the piston 12 at the brake applying position when the piston holding mechanism 34 is actuated, it is constituted by a multi thread screw having higher mechanism efficiency (for example, the mechanical efficiency η is approximately 80 to 90) than the mechanical efficiency of the screw mechanism 52. Therefore, in the present embodiment, the piston holding mechanism 34 can achieve relatively high mechanical efficiency as a whole (for example, the mechanical efficiency η is approximately 20 to 30), because it is constituted by a combination of the screw mechanism 52 having low mechanical efficiency and the plunger pump mechanism 90 having high mechanical efficiency, and therefore it is possible to ensure excellent actuation efficiency of the piston holding mechanism of the disk brake. In the present embodiment, the piston 91 and the nut 99 are prepared as separate bodies, but may be configured as one piece body.

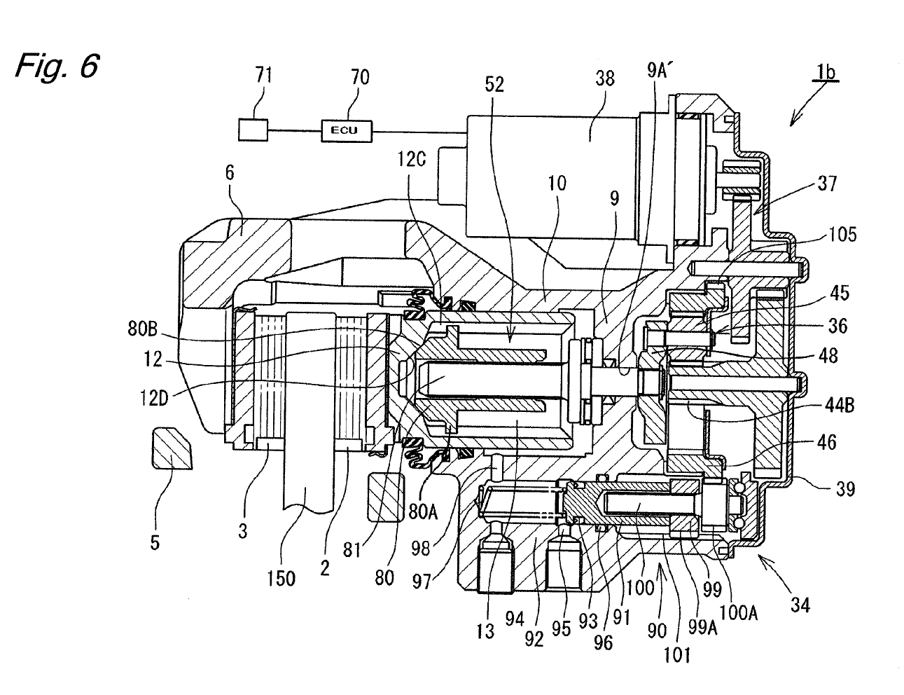

Next, an operation of the disk brake 1b according to the second embodiment will be described below, but the description will be limited to only differences from the operation of the disk brake 1a according to the first embodiment. In particular, the operation of the parking brake will be described as an example of an operation of the disk brake 1b according to the second embodiment for maintaining a braked state of the vehicle. FIG. 5 illustrates the disk brake 1b when the parking brake is released. When the parking brake is actuated, a power supply to the motor 38 does not cause the internal gear 46 to rotate and the plunger pump mechanism 90 to operate, since the biasing force of the return spring 97 is applied to the piston 91 when a brake force (pressing force) to the disk rotor 150 is not generated. Therefore, as shown in FIG. 6, a rotational force from the sun gear 44B of the planetary gear speed reduction mechanism 36 is transmitted to the carrier 48 through the respective planetary gears 45, thereby starting an operation of the screw mechanism 52. Then, in the screw mechanism 52, the spindle 81 is rotated by the rotational force from the carrier 48 to cause the nut 80 to move forward. The inclined surface 80B of the nut 80 starts to abut against the inclined surface 12D of the piston 12 and presses it, thereby causing the piston 12 to move forward.

Next, when the motor 38 is further rotated and a brake force applied to the disk rotor 150 starts to be generated due to the operation of the screw mechanism 52, at this time, the torque for rotating the spindle 81 is increased to become larger than the torque for actuating the plunger pump mechanism 90. As a result, as shown in FIG. 7, the rotational force from the sun gear 44B of the planetary gear speed reduction mechanism 36 is transmitted to the internal gear 46 through the respective planetary gears 45, whereby the plunger pump mechanism 90 starts to operate. Then, in the plunger pump mechanism 90, the pump spindle 100 is rotated by the rotational force from the internal gear 46, causing the piston 91 to move forward together with the nut 99. Then, when the piston 91 moves forward as far as the cup seal 93 moves beyond the port 95, the hydraulic chamber 94 and the hydraulic chamber 13 are separated from the not-shown hydraulic source. Therefore, after that, the hydraulic pressures in the hydraulic chamber 94 and the hydraulic chamber 13 are increased according to a forward movement of the piston 91, thereby causing the piston 12 in the cylinder 10 to further move forward. As a result, the brake force applied from the pair of inner and outer brake pads 2 and 3 to the disk rotor 150 is increased due to an application of the pressing force by the hydraulic pressure from the plunger pump mechanism 90, in addition to the pressing force from the screw mechanism 52. Then, the rotor 38 is further rotated until the brake force applied from the pair of inner and outer brake pads 2 and 3 to the disk rotor 150 reaches a predetermined value.

Next, after the brake force to the disk rotor 150 reaches the predetermined value, the power supply to the motor 38 is stopped. At this time, the hydraulic pressures in the hydraulic chambers 94 and 13 (the reactive force from the pressing force to the disk rotor 150) and the biasing force of the return spring 97 cause only the plunger pump mechanism 90 to operate in the reverse direction from the direction when the mechanism 90 receives an input, and then be returned to the initial position (the position shown in FIG. 6). However, the screw mechanism 52 is not caused to operate by the reactive force from the pressing force, thereby maintaining the brake force as applied. If the hydraulic pressures in the hydraulic chambers 94 and 13 and the biasing force of the return spring 97 are not enough to cause the plunger pump mechanism 90 to operate in the reverse direction, power may be supplied to the motor 38 to cause the motor 38 to rotate in the direction for returning the piston 12, as is the case with the disk brake 1a according to the first embodiment.

Next, when a driver operates the parking switch 71 to release the parking brake, the motor 38 is actuated in the direction for returning the piston 12 based on the control of the ECU 70, and then the multistage spur speed reduction mechanism 37 and the planetary gear speed reduction mechanism 36 are actuated in the direction for returning the piston 12. At this time, since the plunger pump mechanism 90 has been already returned to the initial position, the internal gear 46 of the planetary gear speed reduction mechanism 36 meshed with the pump spindle 100 is not rotated. Therefore, a rotational force from the carrier 48 causes the spindle 81 of the screw mechanism 52 to be rotated in the direction for returning the piston 12, thereby releasing the brake force applied from the pair of inner and outer brake pads 2 and 3 to the disk rotor 150. As is the case with the disk brake 1a according to the first embodiment, only the screw mechanism 52 is actuated when the parking brake is released, and therefore it is possible to reduce the total rotational amount of the motor 38 and improve the responsiveness.

In this way, when the parking brake is actuated, the disk brake 1b according to the second embodiment can apply not only the pressing force from the screw mechanism 52 but also the pressing force by the hydraulic pressure from the plunger pump mechanism 90 as the brake force applied from the pair of inner and outer brake pads 2 and 3 to the disk rotor 150, and therefore can provide the same effects as the disk brake 1a according to the first embodiment.

In addition, in the disk brake 1b according to the second embodiment, for example, when a driver presses the brake pedal to actuate the parking brake in such a state that the hydraulic chamber 13 and the hydraulic chamber 94 already have high hydraulic pressures, the actuation amount of the plunger pump mechanism 90 (the rotational amount of the internal gear 46) is reduced according to the hydraulic pressures. Therefore, in this case, the disk brake 1b according to the second embodiment is advantageous in terms of responsiveness and saving of power consumption.

Japanese Patent Application Public Disclosure No. 2006-177532 discloses a disk brake with use of a worm speed reducer with low mechanical efficiency (i.e., a large mechanical loss) set thereto for maintaining a piston thrust force. Such a disk brake has a problem in that setting low mechanical efficiency to the worm speed reducer reduces the actuation efficiency of the mechanism for achieving the parking brake function, leading to necessity of increasing the size of the motor for compensating the reduced actuation efficiency to generate a desired thrust force to be applied to the piston. On the other hand, according to the above-described embodiments, the piston holding mechanism can have relatively high mechanical efficiency as a whole, because it is constituted by a combination of the one rotation/linear motion conversion mechanism having low mechanical efficiency and the other rotation/linear motion conversion mechanism having high mechanical efficiency. Therefore, it is possible to ensure excellent actuation efficiency of the piston holding mechanism of the disk brake. Accordingly, the size of the motor does not have to be increased, thereby realizing miniaturization of the whole disk brake.

The disk brake according to the above-described first or second embodiment includes the pair of pads disposed on the opposite sides of the disk sandwiched therebetween, a piston configured to pressing one of the pair of pads against the disk, the caliper main body including the cylinder movably containing the piston, the electric motor disposed in the caliper main body, and the piston holding mechanism disposed in the caliper main body for maintaining the piston at the brake applying position. The piston holding mechanism includes the speed reduction mechanism for powering up a rotation of the electric motor, and the first and second rotation/linear motion conversion mechanisms configured to convert a rotation of the speed reduction mechanism to a linear motion to advance the piston in parallel. The speed reduction mechanism transmits a rotational output formed by powering up the input from the electric motor to the first rotation/linear motion conversion mechanism, and a reactive force of the rotational output to the second rotation/linear motion conversion mechanism. At least one of the first and second rotation/linear motion conversion mechanisms is configured to maintain a braked state when an application of the transmission force is stopped.

According to the above-mentioned configuration, it is possible to provide one piston with not only a force transmitted from the first rotation/linear motion conversion mechanism but also a force transmitted from the second rotation/linear motion conversion mechanism during an application of a brake force from the pair of pads to the disk, for maintaining the piston at a brake applying position to achieve, for example, the parking brake function. Therefore, it is possible to ensure excellent actuation efficiency. Further, it is possible to obtain a desired brake force even with an electric motor with a reduced size.

In the disk brake according to the above-described first or second embodiment, the speed reduction mechanism includes the input portion configured to input a rotation of the electric motor, the first output portion configured to transmit the rotational output to one of the two rotation/linear motion conversion mechanisms, and the second output portion configured to transmit a reactive force of the rotational output to the other of the two rotation/linear motion conversion mechanisms. The input portion, the first output portion, and the second output portion are concentrically disposed.

According to the above-described configuration, it is possible to relatively reduce the size of the speed reduction mechanism for obtaining two outputs from one input, thereby enabling miniaturization of the disk brake.

In the disk brake according to the above-described first or second embodiment, the speed reduction mechanism is constituted by a planetary gear speed reduction mechanism.

According to the above-described configuration, use of a simply configured planetary gear speed reduction mechanism as the speed reduction mechanism enables the disk brake to be designed more freely and flexibly. The speed reduction mechanism is not limited to the planetary gear speed reduction mechanism, but may be another known speed reducer including concentric three axes, such as a cycloidal speed reducer and a wave speed reducer.

In the disk brake according to the above-described first or second embodiment, at least one of the two rotation/linear motion conversion mechanisms is a screw mechanism.

According to the above-described configuration, use of a relatively simply configured screw mechanism can improve manufacturing efficiency of the disk brake.

In the disk brake according to the above-described first embodiment, the other of the two rotation/linear motion conversion mechanisms is a ball and ramp mechanism.

According to the above-described configuration, use of the ball and ramp mechanism can improve the actuation efficiency of the piston holding mechanism. Further, since the ball and ramp mechanism can be returned to the initial position when the driving of the electric motor is stopped after the piston reaches the brake applying position, it is possible to improve the actuation efficiency when the piston is returned to the initial position. The other rotation/linear motion conversion mechanism of the two rotation/linear motion conversion mechanisms is not limited to the ball and ramp mechanism, and may be any mechanism having high mechanical efficiency so as to be able to generate a large axial force by a small rotational amount, such as a roller and ramp mechanism.

In the disk brake according to the above-described first embodiment, an adjustment mechanism is disposed between the linear motion member of the above-mentioned screw mechanism and the linear motion member of the above-mentioned ball and ramp mechanism. The adjustment mechanism is coupled with the linear motion member of the above-mentioned screw mechanism, and is configured to be rotated by a linear motion of the linear motion member of the above-mentioned screw mechanism in the direction toward the above-mentioned piston, and to move toward the linear motion member of the above-mentioned ball and ramp mechanism. The above-mentioned ball and ramp mechanism advances the above-mentioned piston through this adjustment mechanism and the linear motion member of the above-mentioned screw mechanism.

In the disk brake according to the above-described first embodiment, the above-mentioned ball and ramp mechanism includes the rotational member configured to be rotated by the above-mentioned speed reduction mechanism, and the linear motion member configured to be linearly moved by the rotational member through the rollable member. The linear motion member is biased toward the rotational member by the biasing means supported by the above-mentioned caliper main body.

According to the above-described configuration, the above-mentioned ball and ramp mechanism has excellent reverse operability due to its high mechanical efficiency, and therefore the linear motion member is returned to the initial position (a position near the rotational member) by the biasing force of the biasing means when the driving of the motor is stopped. Therefore, the holding of the piston can be released only by actuating the screw mechanism, thereby it is possible to reduce the total rotational amount of the motor, and improve the responsiveness and the actuation efficiency of the piston holding mechanism of the disk brake.

In the disk brake according to the above-described first embodiment, the two rotation/linear motion conversion mechanisms are combined as one assembly before they are attached to the caliper main body.

According to the above-described configuration, the parts in the caliper main body can be assembled only by inserting and retaining the above-mentioned assembly into the caliper main body, thereby enabling a reduction in the processes for the assembling of the parts in the caliper main body, resulting in improvement in the manufacturing efficiency of the disk brake.

In the disk brake according to the above-described second embodiment, the other of the two rotation/linear motion conversion mechanisms is a plunger pump mechanism configured to generate a hydraulic pressure.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2010-144262, filed on Jun. 24, 2010. The entire disclosure of Japanese Patent Application No. 2010-144262, filed on June, 2010 including specification, claims, drawings and summary is incorporated herein by reference in its entirety.

What is claimed is:

1. A disk brake comprising:
a pair of pads disposed on opposite sides of a disk so as to sandwich the disk therebetween;
one piston configured to press one of the pair of the pads against the disk;
a caliper main body including a cylinder movably containing the piston;
an electric motor disposed at the caliper main body; and
a piston holding mechanism disposed at the caliper main body and configured to maintain the piston at a brake applying position,
the piston holding mechanism comprising
a speed reduction mechanism configured to power up a rotation of the electric motor, and
a first rotation/linear motion conversion mechanism and a second rotation/linear motion conversion mechanism configured to convert a rotation of the speed reduction mechanism into a linear motion to selectively transmit this force to the one piston to thereby advance the one piston,
wherein the speed reduction mechanism transmits a rotational output provided by powering up an input of the electric motor to the first rotation/linear motion conversion mechanism, and a reactive force of the rotational output to the second rotation/linear motion conversion mechanism, and
wherein at least one of the first and second rotation/linear motion conversion mechanisms maintains a stopped state of the one piston when an application of a transmission force is stopped.

2. The disk brake according to claim 1, wherein the speed reduction mechanism includes an input portion configured to input the rotation of the electric motor, a first output portion configured to transmit the rotational output to the first rotation/linear motion conversion mechanism, and a second output portion configured to transmit the reactive force of the rotational output to the second rotation/linear motion conversion mechanism, and wherein the input portion, the first output portion, and the second output portion are concentrically disposed.

3. The disk brake according to claim 2, wherein the speed reduction mechanism comprises a planetary gear speed reduction mechanism.

4. The disk brake according to claim 1, wherein at least one of the two rotation/linear motion conversion mechanisms is a screw mechanism.

5. The disk brake according to claim 4, wherein the other of the two rotation/linear motion conversion mechanisms is a ball and ramp mechanism.

6. The disk brake according to claim 5, further comprising an adjustment mechanism disposed between a linear motion member of the screw mechanism and a linear motion member of the ball and ramp mechanism, the adjustment mechanism being coupled to the linear motion member of the screw mechanism, the adjustment mechanism being configured to be rotated by a linear motion of the linear motion member of the screw mechanism toward the piston and to move toward the linear motion member of the ball and ramp mechanism,
wherein the ball and ramp mechanism advances the piston through the adjustment mechanism and the linear motion member of the screw mechanism.

7. The disk brake according to claim 5, wherein the ball and ramp mechanism comprises a rotational member configured to be rotated by the speed reduction mechanism, and a linear motion member configured to be linearly moved by the rotational member through a rollable member, and
wherein the linear motion member is biased toward the rotational member by a biasing means supported by the caliper main body side.

8. The disk brake according to claim 4, wherein the other of the two rotation/linear motion conversion mechanisms is a plunger pump mechanism configured to generate a hydraulic pressure.

9. The disk brake according to claim 1, wherein the two rotation/linear motion conversion mechanisms are configured as one assembly before they are attached to the caliper main body.

10. A disk brake comprising:
a caliper main body including one piston for pressing a pair of pads against a disk, the pair of pads being disposed on opposite sides of the disk so as to sandwich the disk therebetween;
an electric motor disposed at the caliper main body; and
a piston holding mechanism disposed at the caliper main body, and configured to maintain the piston advanced by the electric motor at a brake applying position,
the piston holding mechanism comprising
a speed reduction mechanism configured to power up a rotation of the electric motor, and
a first rotation/linear motion conversion mechanism and a second rotation/linear motion conversion mechanism configured to convert a rotation of the speed reduction mechanism into a linear motion to selectively transmit this force to the one piston to thereby advance the one piston, at least one of the first and second rotation/linear motion conversion mechanisms maintaining a stopped state of the one piston when the electric motor is stopped,
the speed reduction mechanism comprising
an input portion configured to input the rotation of the electric motor,
a first output portion configured to transmit a rotational output to the first rotation/linear motion conversion mechanism, and
a second output portion configured to transmit a reactive force of the rotational output to the second rotation/linear motion conversion mechanism,
the input portion, the first output portion, and the second output portion being concentrically disposed.

11. The disk brake according to claim 10, wherein the speed reduction mechanism comprises a planetary gear speed reduction mechanism.

12. The disk brake according to claim 10, wherein at least one of the two rotation/linear motion conversion mechanisms is a screw mechanism.

13. The disk brake according to claim 12, wherein the other of the two rotation/linear motion conversion mechanisms is a ball and ramp mechanism.

14. The disk brake according to claim 13, further comprising an adjustment mechanism disposed between a linear motion member of the screw mechanism and a linear motion member of the ball and ramp mechanism, the adjustment mechanism being coupled to the linear motion member of the screw mechanism, the adjustment mechanism being configured to be rotated by a linear motion of the linear motion member of the screw mechanism toward the piston and to move toward the linear motion member of the ball and ramp mechanism,
wherein the ball and ramp mechanism advances the piston through the adjustment mechanism and the linear motion member of the screw mechanism.

15. The disk brake according to claim 13, wherein the ball and ramp mechanism comprises a rotational member configured to be rotated by the speed reduction mechanism, and a linear motion member configured to be linearly moved by the rotational member through a rollable member, and
wherein the linear motion member is biased toward the rotational member by a biasing means supported by the caliper main body side.

16. The disk brake according to claim 10, wherein the two rotation/linear motion conversion mechanisms are configured as one assembly before they are attached to the caliper main body.

17. A disk brake comprising:
a caliper main body including one piston for pressing a pair of pads against a disk, the pair of pads being disposed on opposite sides of the disk so as to sandwich the disk therebetween; and
a piston holding mechanism configured to maintain the piston advanced by an electric motor at a brake applying position;
the piston holding mechanism comprising
a planetary gear speed reduction mechanism configured to power up a rotation of the electric motor, and
two rotation/linear motion conversion mechanisms configured to convert a rotation of the speed reduction mechanism to a linear motion to selectively transmit this force to the one piston to thereby advance the one piston, at least one of the two rotation/linear motion conversion mechanisms maintaining a stopped state of the one piston when the electric motor is stopped,
the planetary gear speed reduction mechanism comprising
a sun gear configured to input a rotation of the electric motor,
a carrier including a plurality of planetary gears mated with the sun gear on the circumference thereof, the carrier being configured to transmit a rotational output to one of the two rotation/linear motion conversion mechanisms, and
an internal gear mated with the plurality of planetary gears, the internal gear being configured to transmit a reactive force of the rotational output to the other of the two rotation/linear motion conversion mechanisms.

18. The disk brake according to claim 17, wherein at least one of the two rotation/linear motion conversion mechanisms is a screw mechanism.

19. The disk brake according to claim 18, wherein the other of the two rotation/linear motion conversion mechanisms is a ball and ramp mechanism.

20. The disk brake according to claim 17, wherein the two rotation/linear motion conversion mechanisms are configured as one assembly before they are attached to the caliper main body.
